(19) United States
(12) Patent Application Publication
(10) Pub. No.: US 2023/0121058 A1
(43) Pub. Date: Apr. 20, 2023

(54) SYSTEMS AND METHOD FOR RESPONSIVELY AUGMENTING A RISK ENGINE TO ADDRESS NOVEL RISK PATTERNS

(71) Applicant: TLA Innovation, Inc., Paramus, NJ (US)

(72) Inventors: Kala KINYON, Austin, TX (US); Sergio REYES, Cedar Park, TX (US); Ricardo GONZALEZ, Round Rock, TX (US); Jeremy CORBELLO, Cedar Park, TX (US)

(73) Assignee: TLA Innovation, Inc., Paramus, NJ (US)

(21) Appl. No.: 17/967,375

(22) Filed: Oct. 17, 2022

Related U.S. Application Data
(60) Provisional application No. 63/256,886, filed on Oct. 18, 2021.

(51) Int. Cl. G06F 21/31; G06F 21/57

(52) U.S. Cl. CPC G06F 21/316; G06F 21/577; G06F 2221/2135

(57) ABSTRACT

A system and a method to expedite a response of a risk engine to novel threats by detecting an anomalous amount of outlier requests and making more conservative identity assurance assessments during a time period it takes to identify and properly respond to the novel threat. Here, in detecting the novel threats, the response of the risk engine is temporarily altered until the novel threats have subsided or are no longer novel.

### CROSS-REFERENCE TO RELATED APPLICATIONS

This application claims the benefit of U.S. Provisional Application No. 63/256,886, filed Oct. 18, 2021, in the United States Patent Office, the entire contents of which are incorporated herein by reference.

### BACKGROUND OF THE INVENTION

### 1. Field of the Invention

Aspects of this specification relate to applications, systems and methods for detecting novel threats and dynamically adjusting a risk engine's response to the same.

### 2. Description of the Related Art

Risk engines are generally configured to assess observations based on historical data, which makes them inherently slow to react to novel (i.e., previously unobserved) threats in real time. Such systems typically require additional model “training” and/or larger sample counts in order to incorporate a new threat signature. Unfortunately, the delay between identifying a new threat signature and incorporating the same into the risk engine leaves the system vulnerable to exploitation by bad actors.

A number of conventional risk engines exist that allow users to generate custom rules in order to address new threat signatures. However, because such systems require a user to manually detect and analyze novel threats, custom rules can only be implemented after an attack. Indeed, this type of system assumes that the user can recognize and neutralize a new threat signature and that the rule creation capabilities are versatile enough to compose an appropriate rule.

Although modem risk engines employ various machine learning techniques to adapt to threats, such systems still cannot properly handle novel threats until they are no longer novel. That is, such systems require numerous examples of the threat before the risk engine can adapt and properly address the threat. Moreover, even when the required number of examples have occurred, training of the machine learning model may take a long time to execute and/or may not be scheduled immediately, which prolongs the exposure.

Accordingly, there is a need for systems that automatically detect novel threat signatures and dynamically adjust a risk engine's response to the same.

### SUMMARY OF THE INVENTION

According to an aspect, a system and a method are utilized to expedite a response of a risk engine to novel threats by detecting an anomalous amount of outlier requests and making more conservative identity assurance assessments during a time period it takes to identify and properly respond to the novel threat. In detecting the novel threats, the response of the risk engine is temporarily altered until the novel threats have subsided or are no longer novel.

According to an aspect, a system comprises:

a memory to store code to perform instructions;

a processor to execute the instructions received from the memory, the processor comprising:

a risk engine to:
receive a plurality of requests, determine attribute values of each attribute of each request, and determine a risk assessment score of each request based upon the attribute values;
identify, from the plurality of requests, an anomalous volume of outliers over a time frame, wherein the outliers have attribute values about which the risk engine has not been trained to respond; and
use a damper rate to lower the risk assessment score of one of the requests containing one of the outliers, in response to the risk engine identifying the anomalous volume outliers.

According to another aspect, a system comprises:
a memory to store code to perform instructions; and
a risk engine to:
   receive a plurality of requests, determine attribute values of each attribute of each request, and determine a risk assessment score of each request based upon the attribute values;
   identify, from the plurality of requests, an anomalous volume of outliers over a time frame, wherein the outliers have attribute values about which the risk engine has not been trained to respond; and
   apply control limits and a change point detection system per attribute of all of the requests over the time frame to identify both an attribute that the risk engine has not been trained to respond to, along with a time range by which a trainer of the risk engine is able analyze the requests generating outliers and determine whether the attributes of the outliers are a risk or not, to train the risk engine to be able to respond to future requests with attribute values that were generating outliers prior to the training.

According to another aspect, a method comprises:

receiving a plurality of requests, determining attribute values of each attribute of each request, and determine a risk assessment score of each request based upon the attribute values;

identifying, from the plurality of requests, an anomalous volume of outliers over a time frame, wherein the outliers have attribute values about which the risk engine has not been trained to respond; and

using a damper rate to lower the risk assessment score of one of the requests containing one of the outliers, in response to the risk engine identifying the anomalous volume outliers.

According to another aspect, a method comprises:

receiving a plurality of requests, determining attribute values of each attribute of each request, and determine a risk assessment score of each request based upon the attribute values;

identifying, from the plurality of requests, an anomalous volume of outliers over a time frame, wherein the outliers have attribute values about which the risk engine has not been trained to respond; and

applying control limits and a change point detection method per attribute of all of the requests over the time frame to identify both an attribute that the risk engine has not been trained to respond to, along with a time range by which a trainer of the risk engine is able analyze the requests generating outliers and determine whether the attributes of the outliers are a risk or not, to train the risk engine to be able to respond to future requests with attribute values that were generating outliers prior to the training.

### BRIEF DESCRIPTION OF THE DRAWINGS

The details of one or more embodiments of the subject matter of this specification are set forth in the accompanying drawings and the description below. Other features, aspects, and advantages of the subject matter will become apparent from the description, the drawings, and the claims.

FIG. 1 shows an exemplary system according to an embodiment.

FIG. 2 shows an exemplary computing device according to an embodiment.

FIG. 3 shows an exemplary method according to an embodiment.

FIG. 4 shows a graphical representation of an exemplary outlier.

FIGS. 5A-5B show an exemplary control chart and an exemplary change point detection chart, respectively, according to an embodiment.

FIG. 6 shows exemplary outlier rate distribution and control limits charts according to an embodiment.

### DETAILED DESCRIPTION OF THE EMBODIMENTS

In accordance with the foregoing and/or other aspects and objectives, exemplary platforms embodied in systems, computer-implemented methods, apparatuses and/or software applications are described herein. The described platforms expedite a risk engine's response to novel threats by detecting an anomalous amount of outlier events and dynamically adjusting the risk engine's response to the same during the time period it takes to identify the novel threat signature.

If the risk engine detects that too many outliers are appearing, then it makes its assessments more conservative until the risk engine is updated to recognize the new threat and taught how to handle the threat.

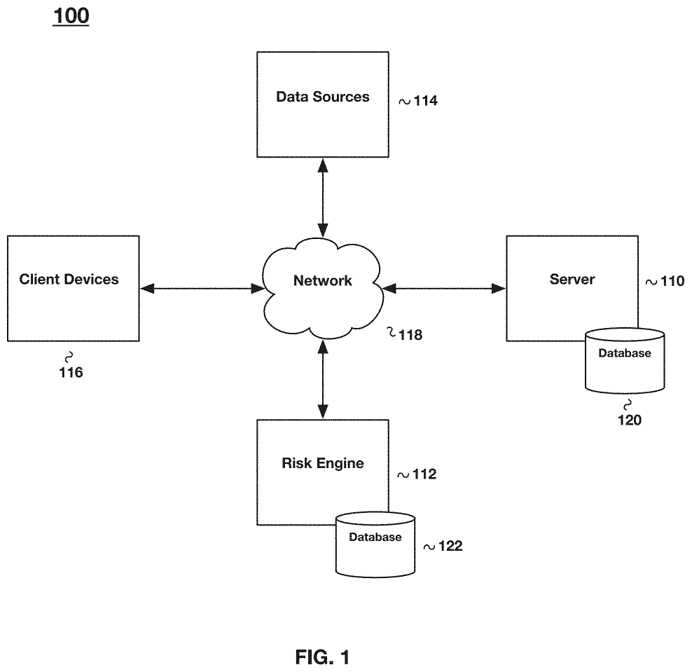

### FIG. 1: System

FIG. 1 illustrates an exemplary system 100 according to an embodiment of the present invention. As shown, the system 100 comprises a server 110 in communication with a risk engine 112, one or more data sources 114 and various client devices 116.

Generally, the server 100 may be configured to receive/transmit information from/to various system components, with or without user interaction via a network 118. The server 110 and the risk engine 112 may also be configured to store such information in one or more local or remote databases 120 and 122, respectively.

In one embodiment, the server 110 may be configured to receive input data from one or more data sources 114 through the network 118). The data sources 114 may comprise any system or device that stores and/or transmits attribute information. For example, data sources 114 may include, but are not limited to: payment and billing systems; user devices, contact management systems, customer relationship management systems, scheduling systems, human resources systems, health care systems, and/or cloud-based storage and backup systems.

Generally, the attribute information provided by such data sources 114 relates to user identification attributes, behavioral information attributes, browser attributes, device attributes, location attributes, access time attributes, session data attributes, and/or others.

User identification attributes may comprise a unique ID, name, contact information (e.g., residence, mailing address, business address, email address, telephone number), emergency contact information, national identification number, social security number, passport number, driver's license number, and/or biometric information (e.g., unique palm identification, unique palm verification or palm Hash ID, retina information, facial recognition information and/or others). Additionally, or alternatively, user identification attributes may comprise various information relating to a patient's gender, ethnicity, race, age (e.g., birth date, birth year, age at a certain date), blood type, marital status, education, profession or occupation, employer information, income level and/or others.

Behavioral information attributes generally comprise information relating a user's behavior with respect to a user device. Exemplary behavioral attributes may include mouse movement speed(s), typing speed, purchasing volume (e.g., scalping detection), unique word frequency (e.g., user input with respect to one or more forms), Captcha performance, and/or others.

Browser attributes may include navigator object attributes that generally represent a state and identity of a user agent (see Appendix A1); screen object attributes that generally represent a screen on which a current window is being rendered (see Appendix A2); installed fonts and/or installed plugins.

### APPENDIX A1

### Navigator Object Attributes

Standard Properties

Navigator.connection Read only [symbol]
Provides a Networkingormation object containing information about the network connection of a device.

Navigator.cookieEnabled Read only
Returns false if setting a cookie will be ignored and true otherwise.

Navigator.credentials Read only
Returns the CredentialsContainer interface which exposes methods to request credentials and notify the user agent when interesting events occur such as successful sign in or sign out.

Navigator.deviceMemory Read only [symbol]
Returns the amount of device memory in gigabytes. This value is an approximation given by rounding to the nearest power of 2 and dividing that number by 1024.

Navigator.doNotTrack Read only [symbol]
Reports the value of the user's do-not-track preference. When this value is “yes”, your web site or application should not track the user.

Navigator.geolocation Read only
Returns a Geolocation object allowing accessing the location of the device.

Navigator.hid Read only
Returns an HID object providing methods for connecting to HID devices, listing attached HID devices, and event handlers for connected HID devices.

Navigator.hardwareConcurrency Read only
Returns the number of logical processor cores available.

Navigator.keyboard Read only [symbol]
Returns a Keyboard object which provides access to functions that retrieve keyboard layout maps and toggle capturing of key presses from the physical keyboard.

Navigator.language Read only
Returns a POMString representing the preferred language of the user, usually the language of the browser UI. The null value is returned when this is unknown.

Navigator.languages Read only [symbol]
Returns an array of POMStrinq representing the languages known to the user, by order of preference.

Navigator.locks Read only [symbol]
Returns a LockManager object which provides methods for requesting a new Lock object and querying for an existing Lock object

Navigator.maxTouchPoints Read only
Returns the maximum number of simultaneous touch contact points are supported by the current device.

Navigator.mediaCapabilities Read only [symbol]
Returns a MediaCapabilities object that can expose information about the decoding and encoding capabilities for a given format and output capabilities.

Navigator.mediaDevices Read only
Returns a reference to a MediaDevices object which can then be used to get information about available media devices (MediaDevices.enumerateDevices(i), find out what constrainable properties are supported for media on the user's computer and user agent (MediaDevices.getSupportedConstraints(i), and to request access to media using MediaDevices.getUserMedia(i).

Navigator.mediaSession Read only [symbol]
Returns MediaSession object which can be used to provide metadata that can be used by the browser to present information about the currently-playing media to the user, such as in a global media controls UI.

Navigator.onLine Read only
Returns a boolean value indicating whether the browser is working online.

Navigator.permissions Read only [symbol]
Returns a Permissions object that can be used to query and update permission status of APIs covered by the Permissions.API.

Navigator.presentation Read only [symbol]
Returns a reference to the Presentation API.

Navigator.serial Read only
Returns a Serial object, which represents the entry point into the Web.serial API to enable the control of serial ports.

Navigator.serviceWorker Read only
Returns a ServiceWorkerContainer object, which provides access to registration, removal, upgrade, and communication with the ServiceWorker objects for the associated document [symbol] .

Navigator.storage Read only
Returns the singleton StorageManager object used for managing persistence permissions and estimating available storage on a site-by-site/app-by-app basis.

Navigator.userAgent Read only
Returns the user agent string for the current browser.

Navigator.userAgentData Road only
Returns a NavigatorUAData object, which gives access to information about the browser and operating system of the user.

Navigator.vendor Read only
Returns the vendor name of the current browser (e.g., “Netscape6”).

Navigator.webdriver Read only [symbol]
Indicates whether the user agent is controlled by automation.

Navigator.xr Read only [symbol]
Returns XRSystem object, which represents the entry point into the WebXR API.

Non-Standard Properties

Navigator.buildID [symbol]
Returns the build identifier of the browser. In modem browsers this property now returns a fixed timestamp as a privacy measure, e.g. 20181001000000 in Firefox 64 onwards.

Navigator.contacts Read only [symbol]
Returns a ContactsManager interface which allows users to select entries from their contact list and share limited details of the selected entries with a website or application.

Navigator.securitypolicy [symbol]
Returns an empty string. In Netscape 4.7x, returns “US & CA domestic policy” or “Export policy”.

Navigator.standalone
Returns a boolean indicating whether the browser is running in standalone mode. Available on Apple's iOS Safari only.

Navigator.wakeLock Read only [symbol]
Returns a WakeLock interface you can use to request screen wake locks and prevent screen from dimming, turning off, or showing a screen saver.

Deprecated Properties

Navigator.appCodeName Read only [symbol]
Returns the internal “code” name of the current browser. Do not rely on this property to return the correct value.

Navigator.appName Read only [symbol]
Returns a DOMString with the official name of the browser. Do not rely on this property to return the correct value.

Navigator.appVersion Read only [symbol]
Returns the version of the browser as a DOMString. Do not rely on this property to return the correct value.

Navigator.activaVRDisplay Read only [symbol]
Returns an array containing every VRDisplay object that is currently presenting (VRDisplay.ispresenting is true).

Navigator.battery Read only [symbol]
Returns a BatteryManager object you can use to get information about the battery charging status.

Navigator.mimeTypes Read only [symbol]
Returns an MimeTypeArray listing the MIME types supported by the browser.

Navigator.oscpu Read only [symbol]
Returns a string that represents the current operating system.

Navigator.platform Read only [symbol]
Returns a string representing the platform of the browser. Do not rely on this function to return a significant value.

Navigator.plugins Read only [symbol]
Returns a PluginArray listing the plugins installed in the browser.

Navigator.product Read only [symbol]
Always returns ‘Gecko’, on any browser. This property is kept only for compatibility purpose.

Navigator.productSub Read only [symbol]
Returns the build number of the current browser (e.g., “20060909”).

Navigator.vendorSub Read only [symbol]
Returns the vendor version number (e g. “6.1”).

### APPENDIX A2

### Screen Object Attributes

Device attributes may include a device manufacturer, device model, processor count, processor speed, processor type, memory properties, device ID (serial number equivalent), operating system type, operating system version, and/or other attributes relating to a user device.

Location attributes may include latitude/longitude, IP Address, distance traveled since last access, blocked IP list, and/or other attributes relating to a user device location.

Access time attributes may include time of day, time zone (e.g., to define business hours), day of the week, and/or others.

Session data attributes may include a session ID, TTL packet settings, network transfer latency information, trace route information and/or others.

Other exemplary attributes may include, but are not limited to a unique mobile user ID and/or seed verification information.

Upon receiving input data from a data source 114, the server 110 may process such data into various datasets comprising values of features relating to attribute information (as discussed above). And such datasets may then be transmitted (e.g., over the network 118), from the server 110 to the risk engine 112 for further processing.

It will be appreciated that the server 110 may process the received input data in accordance with a centralized data schema to create initial data records. In one embodiment, the system 100 may determine various metadata relating to the input data and transactions associated therewith. The system 100 may then associate such metadata with a corresponding initial data record.

The server 110 may also perform various preprocessing steps to clean, validate and/or normalize the initial data records into preprocessed data records. Such preprocessing may be required to create preprocessed data records comprising data tables having a standardized format or schema. As used herein, the term “table” is used in its broadest sense to refer to a grouping of data into a format providing for ease of interpretation or presentation. Such formats may include, but are not limited to, data provided from execution of non-transitory computer program instructions or a software application, a table, a spreadsheet, etc.

Although machine learning techniques are well-equipped to handle common problems of incomplete and/or inaccurate data, a significant amount of preprocessing, cleaning and/or regularization may be employed to ensure the creation of high-quality predictive features. Accordingly, during preprocessing, the system 100 may perform any number of data manipulations on the initial data records to create preprocessed data records therefrom. Some exemplary manipulations may include: joins (an operation performed to establish a connection between two or more database tables, thereby creating a relationship between the tables), filters (a program or section of code that is designed to examine each input or output request for certain qualifying criteria and then process or forward the input or output request accordingly), aggregations (a process in which information is gathered and expressed in a summary form for purposes such as statistical analysis), caching (i.e., storing results for later use), counting, renaming, searching, sorting, and/or other table operations. In one particular embodiment, the system 100 may correlate or index the various ingested raw input data to corresponding unique user records.

It will be appreciated that, although the initial data records may be stored in a different format than the original input data, these records will still contain any underlying user information found in the input data. Accordingly, the system 100 may perform various preprocessing steps to allow such information to be included in preprocessed data records. Such preprocessing ensures, for example, that all user information associated with the preprocessed data records comprises standardized naming conventions, file system layout, and configuration variables.

In any event, the server 110 may calculate various predictive features from the preprocessed user information, and such features may be provided to the risk engine 112 to determine various risk information, such as a predictive value (i.e., a feature weight) of each feature and risk classification.

### Risk Engine

Generally, the risk engine 112 may be considered a classifier, and receives input data as part of a request in order to determine a risk/no-risk classification. The input data can originate from one of the client devices 116, such as an ATM, smart phone, computer, web browser, point of sale device, etc. For security purposes, the originator of the request will typically issue the request to an intermediate server. The originator doesn't typically have direct access to the risk engine 112.

In an identity assurance context, the risk relates to the legitimacy of a user's claim to a particular identity. That is, a “risk” classification represents a false representation of identity and a “no risk” classification represents a valid claim to an identity.

In certain embodiments, the risk engine 112 is adapted to determine risk information/classification relating to any number of user records, update user records with such risk information, and transmit the updated user records to the server 110 for further action (e.g., displaying records, transmitting records and/or executing workflows). Accordingly, the risk engine 112 may comprise an internal or external memory (e.g., database 122) to store various information, such as user records received from the server 110, determined risk information and/or updated user records.

In certain embodiments, the risk engine 112 may comprise a single node. A node typically operates on one attribute and, therefore, may easily classify risk/no-risk without the need for sophisticated classification systems or training.

In other embodiments, the risk engine 112 may comprise a plurality of nodes and/or may implement sophisticated machine learning techniques. Such risk engines operate on multiple attributes from a common source (e.g., user device, browser, etc.) to classify the source as risk/no-risk. The classification process is complex because it must take several attributes into consideration and must be trained.

It will be appreciated that the term “machine learning” generally refers to algorithms that give a computer the ability to learn without being explicitly programmed, including algorithms that learn from and make predictions about data. Machine learning algorithms employed by the embodiments disclosed herein may include, but are not limited to, Naive Bayes classifies, random forest (“RF”), least absolute shrinkage and selection operator (“LASSO”) logistic regression, regularized logistic regression, XGBoost, decision tree learning, artificial neural networks (“ANN”), deep neural networks (“DNN”), support vector machines, rule-based machine learning, and/or others.

For clarity, algorithms such as linear regression or logistic regression can be used as part of a machine learning process. However, it will be understood that using linear regression or another algorithm as part of a machine learning process is distinct from performing a statistical analysis such as regression with a spreadsheet program. Whereas statistical modeling relies on finding relationships between variables (e.g., mathematical equations) to predict an outcome, a machine learning process may continually update model parameters and adjust a classifier as new data becomes available, without relying on explicit or rules-based programming.

In one embodiment, the risk engine 112 may employ modular data processing pipelines to determine risk information, wherein each pipeline may be associated with any number of nodes. Generally, a node comprises a dynamic unit of work that may be connected to, or otherwise combined with, other nodes. To that end, each node may be associated with one or more of the following: input or dependency information (e.g., a location and type of input data to be received by the node), output or results information (e.g., a location and type of output data to generated by the node), logic or computational aspects to manipulate input data, scheduling information, a status, and/or a timeout value. It will be appreciated that data nodes can inherit properties from one or more parent nodes, and that the relationships among nodes may be defined by reference.

The risk engine 112 may include various components to manage and execute pipelines, such as a task scheduler, a task runner and/or one or more computing resources (i.e., workers). Generally, these components work together to execute the pipelines by (1) compiling the various pipeline components, (2) creating a set of actionable tasks, (3) scheduling the tasks, and/or (4) assigning such tasks to a computational resource.

In one embodiment, a scheduler may be employed to split operations into a plurality of tasks, wherein each task is associated with at least one input node and at least one output node, and wherein each task comprises a complete definition of work to be performed. The scheduler may also determine scheduling information for each of the tasks in order to specify when a given task should be executed by a worker. For example, tasks may be scheduled to run on activation, periodically (i.e., at the beginning or end of a predetermined period of time), at a starting time and date, and/or before an ending time and date.

The scheduler may then provide a complete set of tasks and corresponding scheduling information to one or more task runners, which is an executable process, for processing. Generally, task runners are applications that poll a data pipeline for scheduled tasks and then execute those tasks on one or more machines (workers). When a task is assigned to a task runner, the task runner performs the task and reports its status back to the data pipeline. The risk engine's scheduler can determine which work to distribute to a process running on a remote compute server.

It will be appreciated that the execution of computations may be “lazy,” such that the organization of nodes can be performed without executing the nodes until explicitly instructed later. It will be further appreciated that, in some embodiments, the risk engine 112 may be agnostic to lower-level computational scheduling that formulates and allocates tasks among computational resources. That is, the platform may employ one or more third-party systems to schedule and execute low-level data manipulations, such as a single computing device or a distributed clusters of computing devices.

In stark contrast to conventional risk engines, the instant platform may employ longitudinal user data to measure identity assurance in combination with an assessment of a traditional risk assessment.

As further shown in FIG. 1, any number of users may access the server 110 via various client devices 116 connected to the network 118. Generally, a client device 116 may be any device capable of running a client application and/or of communicating with the server 110 (e.g., via a client application or via a web browser). Exemplary client devices 116 may include desktop computers, laptop computers, tablets, smartphones, and/or wearable devices.

The relationship of a client device 116 and the server 110 arises by virtue of computer programs running on respective computers and having a client-server relationship to each other. Accordingly, each of the client devices 116 may have a client application running thereon, where the client application may be adapted to communicate with a server application running on the server 110, for example, over the network 118. Thus, the client application and server 110 may be remote from each other. Such a configuration may allow users, using a client device 116, of client applications to input information and/or interact with the server 110 from any location.

As discussed in detail below, one or more client applications may be adapted to present various user interfaces to users. Such user interfaces may be based on information stored on the client device 116 and/or received from the server 110. Accordingly, client applications may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code).

The client application(s) can be deployed and/or executed on one or more computing devices that are located at one site or distributed across multiple sites and interconnected by a communication network. In one embodiment, a client application may be installed on (or accessed by) one or more client devices 116. It will be apparent to one of ordinary skill in the art that, in certain embodiments, any of the functionality of a client device 116 may be incorporated into the server 110, and vice versa. Likewise, any functionality of a client application may be incorporated into a browser-based client device 116, and such embodiments are intended to be fully within the scope of this disclosure. For example, a browser-based client application could be configured for offline work by adding local storage capability, and a native application could be distributed for various native platforms (e.g., Microsoft Windows™, Apple Mac OS™, Google Android™ or Apple iOS™) via a software layer that executes the browser-based program on the native platform.

In one embodiment, communication between a client application and the server 110 may involve the use of a translation and/or serialization module. A serialization module can convert an object from an in-memory representation to a serialized representation suitable for transmission via HTTP/HTTPS or another transport mechanism. For example, the serialization module may convert data from a native, in-memory representation into one that is acceptable for the risk engine, such as a JSON string for communication over a client-to-server transport protocol.

Similarly, communications of data between a client device 116 and the server 110 may be continuous and automatic, or may be user-triggered. For example, the user may click a button or link, causing the client to send data from the client device 116 to the server 110. Alternately, a client application may automatically send updates to the server 110 periodically without prompting by a user. If a client sends data autonomously, the server 110 may be configured to transmit this data, either automatically or on request, to additional clients and/or third-party systems.

Generally, the network 118 may include one or more wide area networks (“WAN”), local area networks (“LAN”), intranets, the Internet, wireless access networks, wired networks, mobile networks, telephone networks, optical networks, or combinations thereof. The network 118 may be packet switched, circuit switched, of any topology, and may use any communication protocol. Communication links within the network 118 may involve various digital or an analog communication media such as fiber optic cables, free-space optics, waveguides, electrical conductors, wireless links, antennas, radio-frequency communications, and so forth.

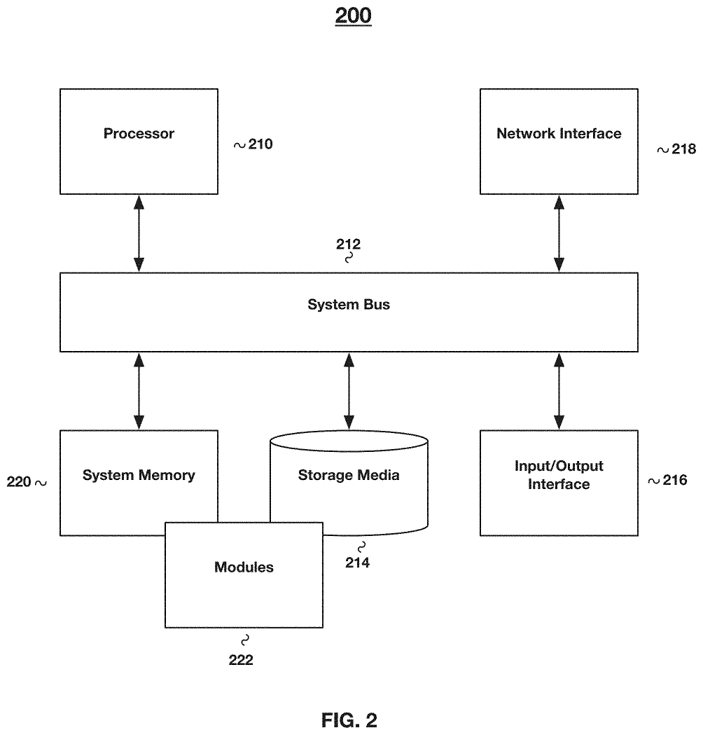

### FIG. 2: Computing Device

Referring to FIG. 2, a block diagram is provided illustrating a computing device 200 and modules in accordance with one or more embodiments presented herein. The computing device 200 may correspond to any of the various computers, servers, mobile devices, embedded systems, or computing systems presented herein (e.g., the client device(s) 116, server(s) 118, and/or data source(s) 114 of FIG. 1).

The computing device 200 may comprise all kinds of apparatuses, devices, and machines for processing data, including but not limited to, a programmable processor, a computer, and/or multiple processors or computers. For example, the computing device 200 may be implemented as a conventional computer system, an embedded controller, a laptop, a server, a mobile device, a smartphone, a tablet, a wearable device, a kiosk, one or more processors associated with a display, a customized machine, any other hardware platform and/or combinations thereof. Moreover, a computing device 200 may be embedded in another device, such as the above-listed devices and/or a portable storage device (e.g., a universal serial bus (“USB”) flash drive). In some embodiments, the computing device 200 may be a distributed system configured to function using multiple computing devices interconnected via a data network or system bus.

As shown, an exemplary computing device 200 may include various internal and/or attached components, such as a processor 210, system bus, system memory 212, storage media 214, input/output interface 216, and network interface 218 for communicating with a network.

The processor 210 may be configured to execute code or instructions to perform the operations and functionality described herein, manage request flow and address mappings, and to perform calculations and generate commands. The processor 210 may be configured to monitor and control the operation of the other components in the computing device 200. The processor 210 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 210 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 210 and/or other components of the computing device may be a virtualized computing device executing within one or more other computing devices.

A system memory 220 may include non-volatile memories such as read-only memory (“ROM”), programmable ROM, erasable programmable ROM, flash memory, or any other device capable of storing program instructions or data with or without applied power. The system memory 220 also may include volatile memories, such as various types of random-access memory (“RAM”). The system memory 220 may be implemented using a single memory module or multiple memory modules 222. While the system memory 220 is depicted as being part of the computing device 200, one skilled in the art will recognize that the system memory 220 may be separate from the computing device 200 without departing from the scope of the subject technology. It should also be appreciated that the system memory 220 may include, or operate in conjunction with, a non-volatile storage device such as the storage media 214.

The storage media 214 may include a hard disk, a compact disc, a digital versatile disc (“DVD”), a Blu-ray disc, a magnetic tape, a flash memory, other non-volatile memory device, a solid-state drive (“SSD”), any magnetic storage device, any optical storage device, any electrical storage device, any semiconductor storage device, any physical-based storage device, any other data storage device, or any combination/multiplicity thereof. The storage media 214 may store one or more operating systems, application programs and program modules such as module, data, or any other information. The storage media 214 may be part of, or connected to, the computing device 200. The storage media 214 may also be part of one or more other computing devices that are in communication with the computing device 200 such as servers, database servers, cloud storage, network attached storage, and so forth.

The modules 222 may comprise one or more hardware or software elements configured to facilitate the computing device 200 with performing the various methods and processing functions presented herein. The modules 222 may include one or more sequences of instructions stored as software or firmware in association with the system memory 220, the storage media 214, or both. The storage media 214 may therefore represent examples of machine or computer readable media on which instructions or code may be stored for execution by the processor 210. Machine or computer readable media may generally refer to any medium or media used to provide instructions to the processor 210. Such machine or computer readable media associated with the modules 222 may comprise a computer software product. It should be appreciated that a computer software product comprising the modules 222 may also be associated with one or more processes or methods for delivering the module 222 to the computing device 200 via the network 118, any signal-bearing medium, or any other communication or delivery technology. The modules 222 may also comprise hardware circuits or information for configuring hardware circuits such as microcode or configuration information for an FPGA or other PLD.

The input/output (“I/O”) interface 216 may be configured to couple to one or more external devices, to receive data from the one or more external devices, and to send data to the one or more external devices. Such external devices along with the various internal devices may also be known as peripheral devices. The I/O interface 216 may include both electrical and physical connections for operably coupling the various peripheral devices to the computing device 200 or the processor 210. The I/O interface 216 may be configured to communicate data, addresses, and control signals between the peripheral devices, the computing device 200, or the processor 210. The I/O interface 216 may be configured to implement any standard interface, such as small computer system interface (“SCSI”), serial-attached SCSI (“SAS”), fiber channel, peripheral component interconnect (“PCI”), serial bus, parallel bus, advanced technology attachment (“ATA”), serial ATA (“SATA”), USB, Thunderbolt, FireWire, various video buses, and the like. The I/O interface 216 may be configured to implement only one interface or bus technology. Alternatively, the I/O interface 216 may be configured to implement multiple interfaces or bus technologies. The/O interface 216 may be configured as part of, all of, or to operate in conjunction with, the system bus 212. The I/O interface 216 may include one or more buffers for buffering transmissions between one or more external devices, internal devices, the computing device 200, or the processor 210.

The I/O interface 216 may couple the computing device 200 to various input devices including mice, touchscreens, scanners, biometric readers, electronic digitizers, sensors, receivers, touchpads, trackballs, cameras, microphones, keyboards, any other pointing devices, or any combinations thereof. When coupled to the computing device 200, such input devices may receive input from a user in any form, including acoustic, speech, visual, or tactile input.

The I/O interface 216 may couple the computing device 200 to various output devices such that feedback may be provided to a user via any form of sensory feedback (e.g., visual feedback, auditory feedback, or tactile feedback). For example, a computing device 200 can interact with a user by sending documents to and receiving documents from a client device 116 that is used by the user (e.g., by sending web pages to a web browser on a user's client device 116 in response to requests received from the web browser). Exemplary output devices may include, but are not limited to, displays, speakers, printers, projectors, tactile feedback devices, automation control, robotic components, actuators, motors, fans, solenoids, valves, pumps, transmitters, signal emitters, lights, and so forth. And exemplary displays include, but are not limited to, one or more of: projectors, cathode ray tube (“CRT”) monitors, liquid crystal displays (“LCD”), light-emitting diode (“LED”) monitors and/or organic light-emitting diode (“OLED”) monitors.

Embodiments of the subject matter described in this specification can be implemented in a computing device 200 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Accordingly, the computing device may operate in a networked environment using logical connections through the network interface to one or more other systems or computing devices across the network 118.

The processor 210 may be connected to the other elements of the computing device 200 or the various peripherals discussed herein through the system bus 212. It should be appreciated that the system bus 212 may be within the processor 210, outside the processor 210, or both. According to some embodiments, any of the processor 210, the other elements of the computing device 200, or the various peripherals discussed herein may be integrated into a single device such as a system on chip (“SOC”), system on package (“SOP”), or ASIC device.

The risk engine 112 runs on the processor 210. The system memory 220 stores code with program instructions to be provided to the processor 210 so that the risk engine 112 is able to perform the above and below described operations.

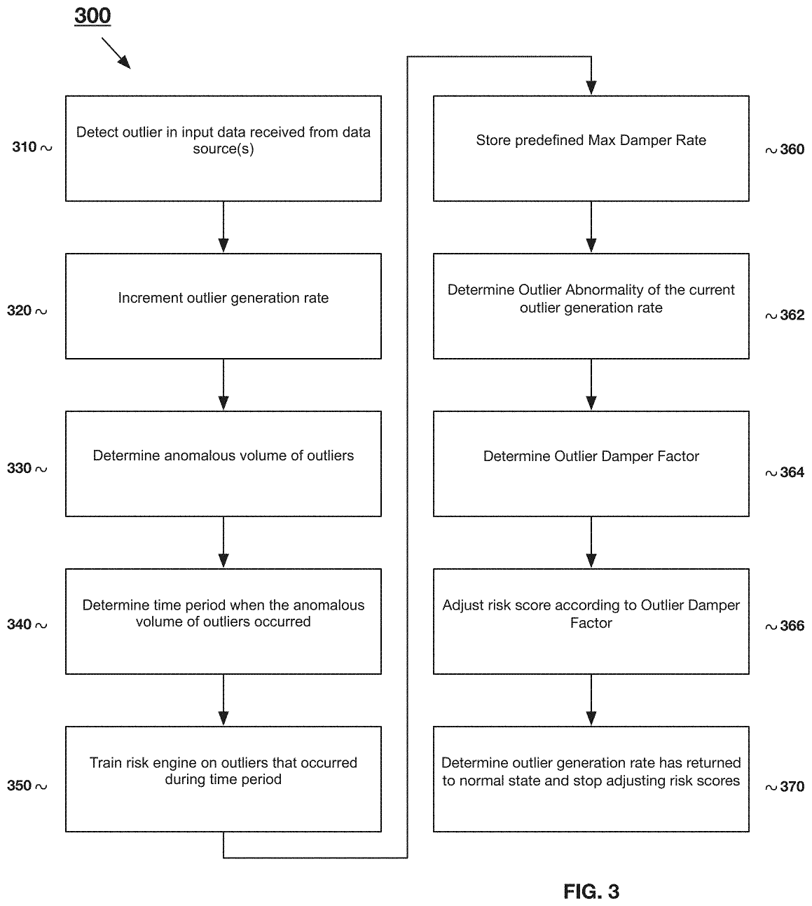

### FIG. 3: Method

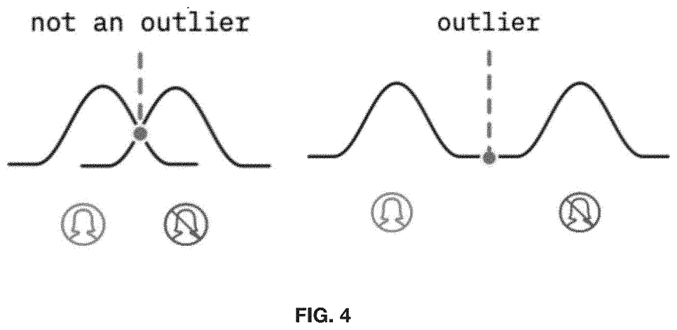

Referring to FIG. 3, an exemplary method 300 is illustrated. As shown, the method 300 begins at Step 310, where the system monitors various attributes in order to detect outliers. As used herein, the term “outlier” refers to an observation that the risk engine 112 determines is associated with both a low probability of being a risk and a low probability of being no-risk. Outliers occur when a classification is inconclusive and, as such, often result from inadequate training of the classification system. See, e.g., FIG. 4.

An attribute is used to evaluate risk. Usually risk engines will have a bell curve (PDF—probability distribution function) per attribute and its classification (risk/no risk). So, each attribute has two bell curves, where each curve describes how well an attribute can be associated with the classification (risk or no risk). A bell curve will always return a probability, but for an outlier (an attribute not commonly observed during the creation of the bell curve), the probability will be very low. Herein, a risk engine outlier is deemed to have occurred when an attribute results in the likelihood/probability of either classification (risk no risk) being low (defined as a z-score >2.5).In one embodiment, an outlier may be detected according to the following:

| | |
|---|---|
| //z-score(pdf,observation) | measures the z-score of an observation on a |
| // | given pdf (probability distribution function) |

```
If abs(z-score(risk_pdf, observation)) > 2.5 and abs(z-score(no-risk_pdf,
observation)) > 2.5
  outlier = true
else
  outlier = false
```

Once an outlier is detected, it can be used to increment an outlier generation rate of a particular attribute (Step 320). Here, a number of outliers, which is a number of times that an attribute could not be used to classify a request as a threat or no threat, is detected over time. That is, an outlier measurement is recorded, for example, in terms of an attribute outlier ratio over time (e.g., minutes):

$$Attribute Outlier Rate = \frac{Attribute Outlier Count / Time Period}{Total Attribute Observations / Time Period}$$

It will be appreciated that a ratio may be used to prevent misinterpreting spikes in outlier counts produced by an increase in total overall observations. Moreover, it will be appreciated that the outlier generation rate may be monitored per attribute; knowledge of past outlier generation rates can be used to build a probability distribution formula, which can then form control limits (discussed below).

At Step 330, the risk engine 112 may determine an anomalous volume of outliers. And at Step 340, the risk engine may determine a range in time when the anomalous volume of outliers occurred.

The risk engine 112, which maintains the rate of outliers for an attribute over time, can determine that the rate of outliers is “too high,” as described by a change point detection (CPD) control chart. The risk engine 112 is simply observing and reporting at this point, not altering the volume of anomalous outliers.

Generally, the risk engine 112 may employ various methods to detect changes in the volume of outliers and to perform quality control, such as control charts and change point detection systems (CPDs). In one embodiment, a control chart may be employed to detect an abnormality (e.g., when an upper or lower limit as set by the risk engine 112 is breached), and a CPD may be employed to identify when the anomaly began. More particularly, a change point analysis may be employed that iteratively uses a combination of cumulative sum charts (CUSUM) and bootstrapping to detect changes in the volume of outliers, as described in Taylor, Wayne, Change-Point Analysis: A Powerful New Tool For Detecting Changes (incorporated by reference herein in its entirety; attached as Appendix B).

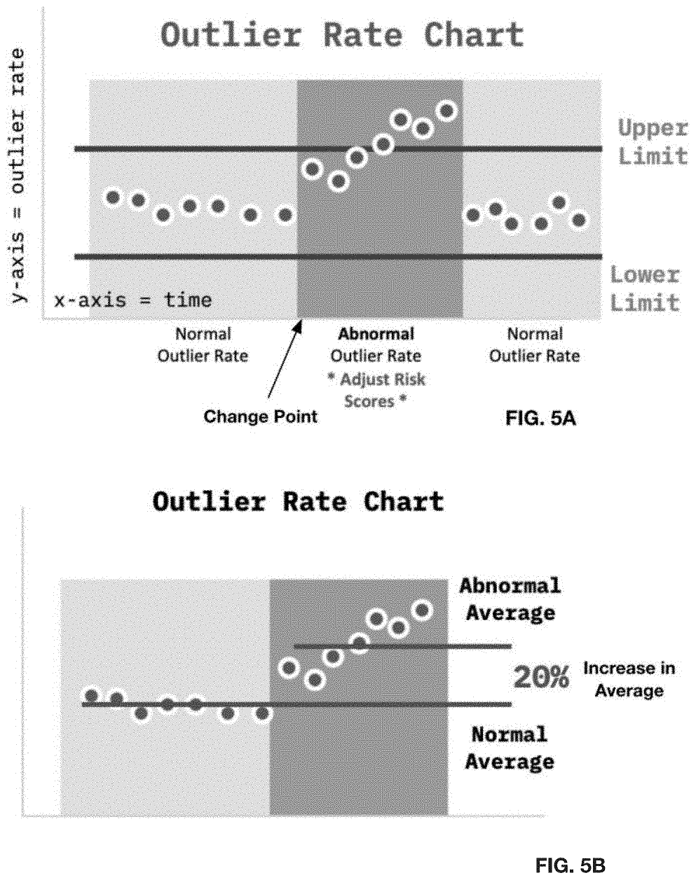

In one embodiment, the analysis may begin with the construction of a CUSUM chart (see FIGS. 5A-5B). Such charts are constructed by calculating and plotting a cumulative sum based on the data. As an example, let X1, X2, . . . , XN represent N data points. From this, the cumulative sums S0, S1, . . . , SN are calculated. The following shows an example calculation where N=24:
1. First calculate the average

$$\overline{X} = \frac{{X}_{1} + {X}_{2} + … + {X}_{24}}{24}$$

2. Start the cumulative sum at zero by setting S₀=0.
3. Calculate the other cumulative sums by adding the difference between current value and the average to the previous sum, i.e., Sᵢ=Sᵢ₊₁+(Xᵢ−X̅) for i=1, 2, . . . , 24.
   The cumulative sums are the cumulative sums of differences between the values and the average. These differences sum to zero, so the cumulative sum always ends at zero (SN=0). The risk engine 112 generates CUSUM charts using a formula that illustrates “the history” of an average. It tells a story of how an average was reached.

Suppose that during a period of time the values tend to be above the overall average. Most of the values added to the cumulative sum will be positive and the sum will steadily increase. A segment of the CUSUM chart with an upward slope indicates a period where the values tend to be above the overall average. Likewise, a segment with a downward slope indicates a period of time where the values tend to be below the overall average. A sudden change in direction of the CUSUM indicates a sudden shift or change in the average. Periods where the CUSUM chart follows a relatively straight path indicate a period where the average did not change.

A confidence level can be determined for any apparent changes by performing a bootstrap analysis. To detect confidence that a change occurred, the original data is compared with the results of randomly re-arranging the data multiple times, and comparing how likely the min/max cusum values of the original data compares to a CUSUM of the same data re-organized in random orders. Before performing the bootstrap analysis, an estimator of the magnitude of the change is required. One choice, which works well regardless of the distribution and despite multiple changes, is Sdiff defined as:

$$\begin{matrix}{S}_{diff} & = & {S}_{max} & - & {S}_{min} where \\ & & {S}_{max} & = & {max}_{i = 0 , … , 24} {S}_{i} \\ & & {S}_{min} & = & {min}_{i = 0 , … , 24} {S}_{i}\end{matrix}$$

Once the estimator of the magnitude of the change has been selected, the bootstrap analysis can be performed. For example:
1. Generate a bootstrap sample of N units, denoted X01, X02, . . . , X0N, by randomly reordering the original N values (i.e., sampling without replacement)
2. Based on the bootstrap sample, calculate the bootstrap CUSUM, denoted S00, S01, . . . , S0N.
3. Calculate the maximum, minimum and difference of the bootstrap CUSUM, denoted S0 max, S0 min, and S0diff.
4. Determine whether the bootstrap difference S_{diff}⁰ is less than the original difference S_{diff}.

The bootstrap samples represent random re-orderings of the data that mimic the behavior of the CUSUM if no change has occurred. By performing a large number of bootstrap samples, an estimate of how much Sdiff would vary if no change took place may be determined. Such estimate may then be compared with the Sdiff value calculated from the data in its original order to determine if this value is consistent with what would be expected if no change occurred.

A bootstrap analysis includes performing a large number of bootstraps and counting the number of bootstraps for which S0diff is less than Sdiff. Let N be the number of bootstrap samples performed and let X be the number of bootstraps for which S0diff<Sdiff. Then the confidence level that a change occurred as a percentage is calculated as follows:

$$Confidence Level = 100 \frac{X}{N} \%$$

Typically, 90% or 95% confidence may be required to determine that a significant change in an anomalous volume of outliers has been detected.

Once a change has been detected (i.e., an anomalous volume of outliers, Step 330), an estimate of when the change occurred is made (Step 340). One such estimator is the CUSUM estimator:

$$\vert {S}_{m} \vert = {max}_{i = 0 , … , 24} \vert {S}_{i} \vert$$

Sm is the point furthest from zero in the CUSUM chart. The point m estimates a last point before the change occurred. The point m+1 estimates the first point after the change.

A second estimator of when the change occurred is the mean square error (MSE) estimator. Let MSE(m) be defined as:

$$MSE ( m ) = {\sum }_{i = 1}^{\underline{m}} {( {X}_{i} - {\overline{X}}_{1} )}^{2} + {\sum }_{i = m + 1}^{24} {( {X}_{i} - {\overline{X}}_{2} )}^{2} where {\overline{X}}_{1} = \frac{{\sum }_{i = 1}^{m} {X}_{i}}{m} and {\overline{X}}_{2} = \frac{{\sum }_{i = m + 1}^{24} {X}_{i}}{24 - m}$$

The MSE error estimator is based on the idea of splitting the data into two segments, 1 to m and m+1 to N, estimating the average of each segment, and then seeing how well the data fits the two estimated averages. The value of m that minimizes MSE(m) is the best estimator of the last point before the change. As before, the point m+1 estimates the first point after the change.

Once a change has been detected, the data can be broken into two segments, one on each side of the change-point, and the analysis is repeated for each segment. For each additional significant change found, continue to split the segments in two. In this manner multiple changes can be detected.

In one embodiment, the changes detected by the above procedure may be considered as a set of candidate change-points. Once this set is generated, all the change-points and their confidence levels may be re-estimated. A backward elimination procedure is then used to eliminate those points that no longer test significant. When a point is eliminated, the surrounding change-points are re-estimated along with their significance levels. This reduces the rate of false detections.

### Example: Outlier Detection

Let us assume that in this example, a risk engine 112 is used to form an identity assurance evaluation. However, it will be appreciated that the process is the same when using the risk engine 112 for other risk assessments.

Assume the following attributes are being processed by the risk engine:
Browser type (e.g., Chrome, Safari, Firefox, etc.)
Browser width (e.g., from about 640 px to about 3840 px)

Assume also that the risk engine 112 has determined, from the current observation for the two attributes, the probability that the identity claim is genuine is: 20% browser and 60% browser width.

This data may be fed to the risk engine 112 (e.g., a Naive-Bayes Classifier) to determine whether the identity can be assured or not. Assume the following examples were used to train the models of the NBC (Naive Bayes Classifier):

No Risk (Positive Identity)

| Browser | Browser Width | In English |
|---|---|---|
| 90% | 95% | An example of positive ID match |

when 90% confident in identity due to browser used and 95% confident
due to width

| | |
|---|---|
| 80% | 90% |

Risk (Can't Positively Identify)

| Browser | Browser Width | |
|---|---|---|
| 95% | 58% | An example of incorrect |

assessment when 95% confident in identity due to browser used and 58%
confident due to width

| | |
|---|---|
| 75% | 77% |

Given the current observation of 20% “browser type” and 60% “browser width”, the browser attribute value of 20% is an outlier for both risk and no-risk classification. Below is a z-stop calculation showing that an observation of 20% confidence in identity assurance for the browser results in −9.2 and −4.6 z-stops when compared to the training data. Because the abs(z-stop)>=2.5 for both the risk and no-risk models, the observation of 20% is considered an outlier.

NO RISK

| | Browser | Browser Width |
|---|---|---|
| AVG: | 85 | 92.5 |
| STDEV: | 7.1 | 3.5 |

RISK

| | Browser | Browser Width |
|---|---|---|
| AVG: | 85 | 67.5 |
| STDEV: | 14.1 | 13.4 |

OBSERVATION: 20 = browser, 60 = browswer_width

| | NO-RISK | RISK |
|---|---|---|
| | Z-Stops | Z-Stops |
| Browser: | −9.2 | −4.6 |
| Browser Width: | −4.5 | −0.6 |

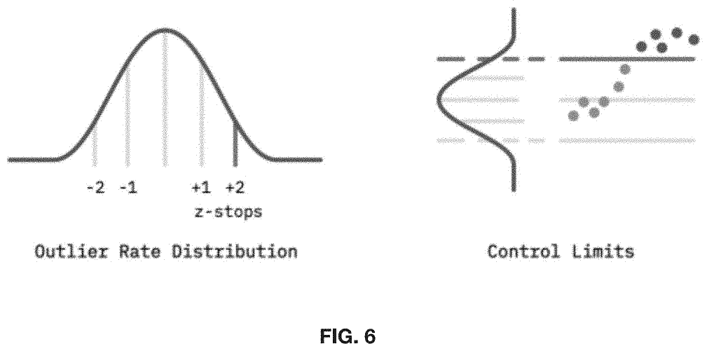

Once the outlier is detected, it can be used to increment the outlier generation rate of the browser attribute. As shown in FIG. 6, knowledge of past outlier generation rates can be used to build a probability distribution formula, which can then form the control limits. And, once the system determines that the upper limit is exceeded, the rate of outliers generated by the browser attribute is considered to be abnormal.

Referring back to FIG. 3, the method continues to Step 350, where the risk engine models may be trained on a newly acquired collection of outliers to learn how to properly classify the observations in the future. In one embodiment, the rate of outliers can be fed into a CPD system to identify the range in time when the anomalous volume of outliers occurred so that samples from the time period can be extracted and used for training. See FIGS. 5A-5B. As the platform acquires and is trained against the data generating the outliers, the future rate of outlier generation should decrease to within normal bounds. That is, the new threat becomes a new rule and the rule weight that the determines impact on risk scores is adjusted to reflect proportional increases in the newly discovered type of threat activity.

### Risk Engine Adjustment

At Steps 360-366, the risk engine 112 is dynamically adjusted to mitigate against novel threats (threats previously unknown) to the platform. Generally, the system 100? may implement a policy where assessment scores (risk scores) will be reduced (i.e., made more conservative) until sufficient training is conducted to correctly classify the new observations. And, importantly, the risk engine 112 100? may perform Steps 360-366 in parallel with Step 350 to allow for a rapid and reasonable response to potential new threats.

At Step 360, the risk engine 112 may store a predefined outlier maximum damper rate (Max Damper Rate), which is a percentage that will be applied to a risk score of outliers in order to make them more conservative. As an example, a Max Damper Rate of 30% may be employed to lower a risk score by up to 30%. Generally, the Max Damper Rate may range from about 30% to about 60%, as desired or required.

At step 362, the risk engine 112 determines the outlier abnormality rate (Outlier Abnormality) of the current outlier generation rate. As shown in, for example in FIG. 5B, the Outlier Abnormality (20%) is a measure of the increase in the average outlier rate. In one embodiment, the Outlier Abnormality may be determined according to the following equation:

Outlier Abnormality=1−(Previous Attribute Outlier Rate/Current Attribute Outlier Rate),

where “previous” refers to a time period when the outlier rate was considered normal, and “current” refers to a time period when the outlier rate is abnormal. As discussed above, a CPD may be employed to determine the previous and current time periods.

At Step 364, the risk engine 112 determines an Outlier Damper Factor, which indicates how much to damper the risk engine assessment (i.e., the attribute-specific risk score calculated by the risk engine 112). In one embodiment, the Outlier Damper Factor is determined according to the following equation:

Outlier Damper Factor=Outlier Abnormality×Max Damper Rate

As an example, if the Outlier Abnormality is equal to 20% and the Max Damper Rate is equal to 30%, the Outlier Damper Factor will be equal to 6% (i.e., 20%*30%). Accordingly, the Dampened Risk Score for the outlier will be made more conservative (altering the risk score in a manner which favors risk over non-risk) by 6%.

At Step 366, the risk engine 112 applies the Outlier Damper Factor to an overall risk assessment score to reflect risk of misidentification due to an anomalous volume of outliers data provided to the risk engine 112 in recent analysis requests. For example, assuming an Initial Risk Score of 90%, the Dampened Risk Score may be calculated as follows:

$$Dampened Risk Score = ( 100 - Outlier Damper Factor ) ⨯ Initial Risk Score = ( 100 - 6 ) ⨯ 90 = 84.6$$

Accordingly, the risk score is made more conservative by lowering it from 90 to 84.6. It will be appreciated that, in the above embodiment, a lower risk score indicates a higher risk of fraudulent interaction.

In certain embodiments, an adjustment can be made to compensate for situations where an outlier has been confirmed to be associated with a real threat (e.g., via input from a system administrator). In such cases, the risk engine 112 may employ an Unconfirmed Damper factor and a Confirmed Damper factor to adjust the overall dampening. For example:

Example:

```
unconfirmed_damper=30%; confirmed_damper=60%;
if (in_above_average_outlier_generation_state)
  if (a_minimal_threshold_of_outliers_observed_in_current_state_confirmed_to_be_a_threat)
    Outlier_Max_Damper_Rate = confirmed_damper
  else
    Outlier_Max_Damper_Rate = unconfirmed_damper
proceed with steps B,C,G as normal using Outlier_Max_Damper_Rate
```

As shown in the following example, the Outlier Damper Factor will be applied to the overall risk assessment score for each attribute that is abnormal. Importantly, only observations considered to be outliers will have their risk scores adjusted according to the above process. Thus, the net effect is that the risk assessment generated by the risk engine 112 will be made more conservative until the outlier rate for the abnormal attribute is within a normal range.

### Example: Browser Advisor—Outlier Dampening

Example: Browser ID Assurance Score=61.1
Damper Rate for browser type attribute=6%
New Browser ID Assurance Score=0.94*61.1=57.434
Damper Rate for browser_language=10%
New Browser ID Assurance Score=0.90*57.434=51.691
Final contribution of the Browser Advisor to the total ID Assurance Score reduced from 61.1 to 57.4.

The damper factor will be applied to the risk assessment score. In this case a low score reflects more risk; thus, the score will be “dampered” because at this point in time the risk engine is seeing above normal volume of anomalies for an attribute that this analysis request also displays.

Finally, at Step 370, the risk engine 112 determines that the outlier generation rate has returned to a normal state and stops adjusting the risk scores. See FIG. 5A.

As explained below, the risk engine 112 may take additional steps upon determining an anomalous volume of outliers (Step 330). In certain embodiments, the risk engine 112 may transmit or display some or all outlier information via one or more reports, notifications, alerts, webhooks, or API calls. For example, the risk engine 112 may take threat confirmations as input from a case management system, which will make risk scores more conservative. As another example, the platform may allow for an administrator to analyze outlier examples in order to provide confirmation that processing errors are not the cause of the increase in outlier rates. The following is a non-limiting example of the process shown in FIG. 3 according to a real-life scenario, but of course many other applications are contemplated.

In this example, the risk engine 112 examines various attribute values to generate a risk score, which is a quantification of risk posed by a request to the requestor. An example could be a bank (the requestor), submitting a risk engine analysis request to quantify the risk in allowing a customer to login to their account through a webpage. The bank's webpage can present various attributes to the risk engine 112, such as IP address, user location, device id, etc. The risk engine 112 will examine the values to these attributes to generate a risk score.

Suppose the requestor is a bank whose customer base is primarily in the United States and is in the process of expanding its services to a Canadian customer base. One of the attributes the bank submits to the risk engine 112 is location, and the risk engine is currently trained to recognize a location value of United States to be a non-risk. If presented with a location attribute value other than the United States, like Canada, the risk engine would consider this to be an outlier, an attribute value that it is not trained to process, because to the risk engine the attribute value is neither a risk nor non-risk.

The risk engine 112 has seen location attribute values other than United States in the past in low numbers and considered this normal behavior because the risk engine's use of a change point detection (CPD) algorithm defined it as normal behavior.

The damper factor causes any risk engine analysis request with a location outlier to produce a lower risk score indicating a higher level of risk. The damper factor changes in proportion with the volume of outliers generated by the location attribute to indicate higher levels of risk in proportion to the rate of outliers being generated.

Through the risk engine's use of a change point detection system, the risk engine 112 can determine that there is an anomalous volume of location attribute outliers, and the time at which the anomaly began. This information is useful to the risk engine administrator, who is responsible for training the risk engine 112. The administrator can take past risk engine analysis requests containing the outlier and realize that the location value of Canada is causing the risk engine 112 to generate outliers.

After analyzing the past risk engine analysis requests and realizing the expansion of bank services into Canada, the administrator can then train the risk engine 112 that a location attribute value of Canada is not a risk. With this new training, the location attribute outlier rate will decrease because a location attribute value of Canada is no longer considered an outlier, meaning the risk engine 112 knows to process Canada as a non-threat when it is specified as a location attribute value.

Once trained, the generation of outliers for the location attribute will decrease until the outlier rate reaches a level considered normal by the risk engine's change point detection system, causing the removal of the damper rate that was causing all risk engine analysis requests with location attribute outliers to have risk engine scores adjusted to reflect high levels of risk.

### Client Applications

In certain embodiments, the platform may include one or more client applications adapted to provide outlier information to users via one or more screens comprising various user interface elements (e.g., graphs, charts, tables, lists, text, images, etc.). The user interface elements may be viewed and manipulated (e.g., filtered, sorted, searched, zoomed, positioned, etc.) by a user in order to understand insights about the risk engine 112 and/or to adjust various settings.

### Case Management Application

A case management application, an interface to a customer, may be provided to open tickets according to normal practices, meaning that an increase rate in outlier generation may not result in a new ticket. Tickets may continue to be opened when an identity assurance score is too risky. The case details may have reference to the attributes contributing to the high-risk score, including the attribute that was deemed an outlier. Reference to the high outlier rate may also be mentioned. The responsibility of end user is to confirm the risk assessment of the case, not the abnormal rate in outlier generation.

In one embodiment, if enough cases that contain the anomalous outlier are confirmed as fraudulent through case management, the damper ratio may be automatically increased. As a result, the risk engine 112 will continue to make assessment scores more conservative.

### Outlier Management Application

In certain embodiments, the risk engine 112 may provide a user or administrator, such as a software engineer or other operator, of the identity assurance platform with information about an abnormal outlier generation rate once it passes an upper control limit. The user/administrator may then inspect samples identified through the CPD system prior to training in order to identify whether the abnormality is a result of a data processing change/error or new and legitimate observations. In the case of an error, the corresponding attribute may be temporarily disregarded by the platform until the problem is corrected. However, if the observations are error free, they may automatically be applied to training.

In the case that various attributes are generating outliers at an above normal rate, additional analysis by the approaches can be conducted to attempt to find relationships between attributes. Such approaches may include, but are not limited to: K-Means, Support Vector Machines, Random Forest, Neural Networks, etc.

### ML Engine Training & Validation

It will be appreciated that, in order to accurately determine risk information, a model is to be configured, trained and validated. In one embodiment, a user may input various model information into the risk engine 112 to configure a given machine learning model. Exemplary model information may include, but is not limited to, a definition of a target variable or outcome for which predictions are to be made, observation window information, prediction window information, transformation or activation functions information relating to the training data to be employed by the model and/or initial parameters/weights.

Generally, the “learning” or “training” of a machine learning model refers to altering or changing model parameters to improve the overall predictive performance of the model. Determining the specific parameters w to be used in a model is an example of the more general problem of learning a mapping from data. Given a training data set D comprising a number N of examples of pairs of input and corresponding output observations (i.e., D={(x₁,y₁) . . . , (x_{N}, y_{N})}), the goal is to learn a mapping that approximates the mapping on the training set and, importantly, that also generalizes and/or extrapolates well to unseen test data drawn from the same probability distribution as the pairs in the training data set D.

To learn such a mapping, an error function is defined to measure the positive utility (in the case of an objective function) or the negative utility (in the case of a loss function) of a mapping that provides an output y′ from input x when the desired output is y. When the error function is a loss function, the error on a given training dataset may be defined for a mapping as the sum of the losses (i.e., empirical loss).

Many error functions may be employed to train the disclosed machine learning models, including functions that include regularization terms that prevent overfitting to the training data, functions derived from likelihoods or posteriors of probabilistic models, functions that are based on sub-sampling large data sets, or other approximations to the loss function of interest (so called “surrogate loss functions”). Generally, the error may be computed either on the entire training data or may be approximated by computing the error on a small sub-sample (or mini batch) of the training data.

Training generally occurs based on some example data D, by optimizing the error function E using an optimization algorithm. For example, the error function can be minimized by starting from some initial parameter values w_{θ} and then taking partial derivatives of E(w,D) with respect to the parameters w and adjusting w in the direction given by these derivatives (e.g., according to the steepest descent optimization algorithm). It will be appreciated that any number of optimization algorithms may be employed to train the disclosed machine learning models, including, for example, the use of stochastic gradients, variable adaptive step-sizes, η_t, second-order derivatives, approximations thereof and/or combinations thereof. Typically, the model may be validated by repeating the above steps using one or more additional validation datasets. For example, the same or similar data preprocessing, feature calculation, and outcome calculation process can be repeated for one or more validation datasets. And the features can be fed into the trained machine learning model to determine risk scores.

Performance metrics may also be calculated based on the risk scores and outcomes output by the model. It will be appreciated that a valid or robust model should expect similar performance metrics on the additional dataset as performance metrics calculated from a hold-out subsample of data that the model was originally trained on.

Generally, the above-described training and validation process (or any subset thereof) may be repeated until a stopping criterion is reached. The stopping criterion may be any function that depends on the error or other performance measure computed on the training data, validation data or other data augmented to potentially include a regularization term.

Once trained and validated, the machine learning models can determine risk information for new input data as desired or required. Accordingly, newly available information may be re-inputted, preprocessed, and then features calculated for the machine learning model to calculate revised risk scores based on the relative feature weights generated on the training data. In one embodiment, the ML model may re-calculate the individual risk scores at regular intervals as new input data is made available.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references, including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A system comprising:
a memory to store code to perform instructions;
a processor to execute the instructions received from the memory, the processor comprising:
a risk engine to:
receive a plurality of requests, determine attribute values of each attribute of each request, and determine a risk assessment score of each request based upon the attribute values;
identify, from the plurality of requests, an anomalous volume of outliers over a time frame, wherein the outliers have attribute values about which the risk engine has not been trained to respond; and
use a damper rate to lower the risk assessment score of one of the requests containing one of the outliers, in response to the risk engine identifying the anomalous volume outliers.

2. The system according to claim 1, wherein the risk engine increases the damper rate in accordance with a rate of increase of the outliers over the time frame.

3. The system according to claim 2, wherein the risk engine:
sets a maximum damper rate, which is a maximum percentage that is applied to the risk assessment score of the request containing the outlier to make the request more conservative;
determines an outer abnormality rate which is a measure of an increase in an average outlier rate; and
determines the damper rate based upon the maximum damper rate and the outer abnormality rate.

4. The system according to claim 3, wherein the risk engine determines the damper rate by multiplying the outer abnormality rate by the maximum damper rate.

5. The system according to claim 3, wherein the outer abnormality rate equals:
1−(a previous attribute outlier rate/a current attribute outlier rate),
where previous refers to a time period when the outlier rate was considered normal, and
current refers to a second time period where the outlier rate is considered abnormal.

6. The system according to claim 1, wherein the risk engine increases the damper rate in accordance with being informed that one of the attributes of one of the outliers is associated with malicious activity.

7. The system according to claim 1, wherein the risk engine stops using the damper rate in response to determining that a rate of outliers over a period of time lowers to a normal range.

8. A system comprising:
a memory to store code to perform instructions; and
a risk engine to:
receive a plurality of requests, determine attribute values of each attribute of each request, and determine a risk assessment score of each request based upon the attribute values;
identify, from the plurality of requests, an anomalous volume of outliers over a time frame, wherein the outliers have attribute values about which the risk engine has not been trained to respond; and
apply control limits and a change point detection system per attribute of all of the requests over the time frame to identify both an attribute that the risk engine has not been trained to respond to, along with a time range by which a trainer of the risk engine is able analyze the requests generating outliers and determine whether the attributes of the outliers are a risk or not, to train the risk engine to be able to respond to future requests with attribute values that were generating outliers prior to the training.

9. The systems according to claim 8, wherein the risk engine uses a damper rate to lower the risk assessment score of one of the requests containing one of the outliers, in response to the risk engine identifying the anomalous volume of outliers.

10. The system according to claim 9, wherein the risk engine increases the damper rate in accordance with a rate of increase of the outliers over the time frame.

11. The system according to claim 8, wherein the risk engine:
sets a maximum damper rate, which is a maximum percentage that is applied to the risk assessment score of the request containing the outlier to make the request more conservative;
determines an outer abnormality rate which is a measure of an increase in an average outlier rate; and
determines the damper rate based upon the maximum damper rate and the outer abnormality rate.

12. The system according to claim 11, wherein the risk engine determines the damper rate by multiplying the outer abnormality rate by the maximum damper rate.

13. The system according to claim 12, wherein the outer abnormality rate equals:
1−(a previous attribute outlier rate/a current attribute outlier rate);
where previous refers to a time period when the outlier rate was considered normal, and
current refers to a second time period where the outlier rate is considered abnormal.

14. The system according to claim 9, wherein the risk engine increases the damper rate in accordance with being informed that one of the attributes of one of the outliers is associated with malicious activity.

15. The system according to claim 9, wherein the risk engine stops using the damper rate in response to determining that a rate of outliers over a period of time lowers to a normal range.

16. A method comprising:
receiving a plurality of requests, determining attribute values of each attribute of each request, and determine a risk assessment score of each request based upon the attribute values;
identifying, from the plurality of requests, an anomalous volume of outliers over a time frame, wherein the outliers have attribute values about which the risk engine has not been trained to respond; and
using a damper rate to lower the risk assessment score of one of the requests containing one of the outliers, in response to the risk engine identifying the anomalous volume outliers.

17. The method according to claim 16, wherein the using the damper rate comprises increasing the damper rate in accordance with a rate of increase of the outliers over the time frame.

18. The method according to claim 15, further comprising:
setting a maximum damper rate, which is a maximum percentage that is applied to the risk assessment score of the request containing the outlier to make the request more conservative;
determining an outer abnormality rate which is a measure of an increase in an average outlier rate; and
determining the damper rate based upon the maximum damper rate and the outer abnormality rate.

19. The method according to claim 18, further comprising determining the damper rate by multiplying the outer abnormality rate by the maximum damper rate.

20. The method according to claim 18, wherein the outer abnormality rate equals:
1−(a previous attribute outlier rate/a current attribute outlier rate),
where previous refers to a time period when the outlier rate was considered normal, and current refers to a second time period where the outlier rate is considered abnormal.

21. The method according to claim 16 wherein the using the damper rate comprises increasing the damper rate in accordance with being informed that one of the attributes of one of the outliers is associated with malicious activity.

22. The method according to claim 16, further comprising stopping using the damper rate in response to determining that a rate of outliers over a period of time lowers to a normal range.

23. A method comprising:
receiving a plurality of requests, determining attribute values of each attribute of each request, and determine a risk assessment score of each request based upon the attribute values;
identifying, from the plurality of requests, an anomalous volume of outliers over a time frame, wherein the outliers have attribute values about which the risk engine has not been trained to respond; and
applying control limits and a change point detection method per attribute of all of the requests over the time frame to identify both an attribute that the risk engine has not been trained to respond to, along with a time range by which a trainer of the risk engine is able analyze the requests generating outliers and determine whether the attributes of the outliers are a risk or not, to train the risk engine to be able to respond to future requests with attribute values that were generating outliers prior to the training.

24. The method according to claim 23, further comprising using a damper rate to lower the risk assessment score of one of the requests containing one of the outliers, in response to the risk engine identifying the anomalous volume of outliers.

25. The method according to claim 24, wherein the using the damper rate comprises increasing the damper rate in accordance with a rate of increase of the outliers over the time frame.

26. The method according to claim 23, further comprising:
setting a maximum damper rate, which is a maximum percentage that is applied to the risk assessment score of the request containing the outlier to make the request more conservative;
determining an outer abnormality rate which is a measure of an increase in an average outlier rate; and
determining the damper rate based upon the maximum damper rate and the outer abnormality rate.

27. The method according to claim 26, further comprising determining the damper rate by multiplying the outer abnormality rate by the maximum damper rate.

28. The method according to claim 27, wherein the outer abnormality rate equals:
1−(a previous attribute outlier rate/a current attribute outlier rate),
where previous refers to a time period when the outlier rate was considered normal, and
current refers to a second time period where the outlier rate is considered abnormal.

29. The method according to claim 24, wherein the using the damper rate comprises increasing the damper rate in accordance with being informed that one of the attributes of one of the outliers is associated with malicious activity.

30. The method according to claim 24, further comprising stopping using the damper rate in response to determining that a rate of outliers over a period of time lowers to a normal range.
